(19) United States
(12) Patent Application Publication
(10) Pub. No.: US 2021/0303649 A1
(43) Pub. Date: Sep. 30, 2021

(54) BOOK RECOMMENDATION METHOD UTILIZING SIMILARITY BETWEEN BOOKS

(71) Applicant: BRAINCOLLA INC., Seoul (KR)

(72) Inventors: Kang San KIM, Yongin-si, Gyeonggi-do (KR); Ji Hoon PARK, Seoul (KR)

(73) Assignee: BRAINCOLLA INC., Seoul (KR)

(21) Appl. No.: 17/262,230

(22) PCT Filed: Jul. 27, 2018
(86) PCT No.: PCT/KR2018/008506

§ 371 Date: Jan. 22, 2021

(51) Int. Cl. G06F 16/9535; G06F 16/9536; G06F 16/901; G06F 16/908

(52) U.S. Cl. CPC G06F 16/9535; G06F 16/908; G06F 16/9024; G06F 16/9536

(57) ABSTRACT

A book recommendation method includes, (1) a step in which a book recommendation server generates a story flow emotion graph for each of the plural number of books; (2) a step in which the book recommendation server calculates the similarity between the story flow emotion graph of a first book and the story flow emotion graph of a second book; and (3) a step of displaying one or more similar books similar to the first book according to the similarity by the book recommendation server.

### TECHNICAL FIELD

The present invention relates to the book recommendation method using similarity between books.

### TECHNOLOGY USED FOR THE INVENTION

From the past, there have been services to record and manage books that have been read and share reviews of books. In addition, a related book recommendation service is also being implemented, and although the service is in a process of being developed in Korea, book recommendation service is being firmly established overseas, especially in the United States. These book recommendation services are currently being offered in conjunction with smartphone applications as well as Internet websites.

When reviewing patents related to carrying out the domestic book recommendation services, there is a “Book Social Network Service System and providing method thereof” (No. 10-2014-0038017, Date of Publication 2014, Mar. 28). In this published patent, a concept of sharing the contents of other users based on Social Networking Service (SNS) for book recommendation and using it for book recommendation is disclosed. In “Method for providing social networking service sharing reading information and system therefor” (No. 10-2014-0133647, Date of Publication 2014, Nov. 20), a patent related to other domestic book recommendation services, only a concept that a reader who read a book will share information about the book with other readers through SNS is disclosed.

All of the preceding book recommendation methods are limited to recommending books to readers using SNS or personalized information, and there is no clear disclosure of how to analyze and classify actual contents of the book and recommend it.

Accordingly, the inventor of the present invention suggested a method of recommending a book that readers may be interested in by analyzing the contents of the book.

### DETAILED DESCRIPTION OF THE INVENTION

### Technical Problem

The present invention is to provide the book recommendation method using similarity between books.

### Means for Solving Problems

According to operational aspect of the present invention, the book recommendation method based on similarity between books is provided, which includes, (1) A step in which book recommendation server generates story flow emotion graphs for each of the books; (2) A step where a book recommendation server computes similarity between the story flow emotion graph for a first book and the story flow emotion graph for a second book; (3) A step where the book recommendation server outputs one or more similar books similar to the first book according to the similarity.

In addition, the step (1) may further include more steps to select the target book to generate the story flow emotion graph using a genre information of the book.

In addition, the step (1) may include a step to generate a window for analyzing a number of words in a predetermined ratio with respect to a number of all words included in each book; and a step to generate the story flow emotion graph after analyzing the emotions of the words included within the window at the position in a moved book by sequentially moving the window from the word in a first position included in each book to the story direction of the book, which is a word direction in a second position.

In addition, the step of generating a story flow emotion graph by sequentially moving the window from the word at the first position included in each book to the story direction of the book, which is the word direction at the second position, and analyzing the emotions included within the window at the position in the moved book can include more steps such as: a step of assigning an emotion value for each word included in the window by referring to words included in a predefined emotion word table; a step of deriving a unit emotion sum value obtained by summing emotion values for each word in the window; and a step of displaying the story flow emotion graph based on the unit emotion sum value. Furthermore, based on the unit emotion sum value, a data can be generated for the story flow emotion graph.

Also, the step of generating a story flow emotion graph by sequentially moving the window from the word at the first position included in each book to the story direction of the book, which is the word direction at the second position, and analyzing the emotions included within the window at the position in the moved book can move the window by an average number of words of the number of words included in each page of the book to be analyzed.

The step (2) may be computed on the basis of one or more of the similarity judgment base value from: a first similarity judgment base value indicating the difference between the unit emotion sum value of the first book according to the story direction and the unit emotion sum value of the second book according to the story direction; and a second similarity judgment base value representing an amount of change of the first similarity judgment base value.

The first book may be a book that has been given a rating score higher than a predetermined reference value by an user, a book included in a shopping cart of an online shopping mall, or a book in which related book information has been viewed in an online space by the user.

The step (3) may further include one or more steps from: a step of excluding books read by a user among one or more of the similar books; a step of displaying similar books in the order of book ratings among one or more of the similar books; and a step of displaying similar books in consideration of user information among one or more of the similar books.

According to another aspect of the present invention, it may be a computer program stored in a recording medium that executes the method.

### Effect of the Invention

Following the present invention can provide the book recommendation method.

### BRIEF DESCRIPTION OF THE DRAWING

FIG. 1 is a configuration diagram of a book recommendation system according to the present invention

FIG. 2 is a conceptual diagram for describing a generation of window and story flow emotion graphs

FIG. 3 is a table of emotion values of words representing an emotion of happiness included in the emotion word database

FIG. 4 is a diagram showing a page of a book in which the words assigned with emotion values are present

FIG. 5 is a graph showing the change of the unit emotion sum value according to the direction of the story flow

FIG. 6 is a table showing the unit emotion sum value of books according to the examples of embodiments

FIG. 7 is an emotion graph based on story flow

FIG. 8 is a table showing the similarity judgment base value

FIG. 9 to FIG. 12 are flow charts according to the present invention

### BEST MODE FOR CARRYING OUT THE INVENTION

The present invention is capable of various modifications and various embodiments, and particular embodiments are illustrated in the drawings and described in detail in the detailed description. However, it should be understood that the present invention is not limited to specific embodiments and includes all transformations, equivalents or substitutes within the scope of the idea and technology of the invention. In describing the present invention, if the detailed description of the relevant prior art is deemed to be obscuring the summary of the invention, the detailed description thereof will be omitted.

Terms such as first and second may be used to describe various components, but the components should not be limited by the terms. The terms are only used for the purpose of distinguishing one component from other components.

The terms used in this application are only used to describe particular embodiments, and are not to limit the present invention. Singular expressions include plural expressions unless the context clearly indicates otherwise. In this application, terms such as “including” or “having” shall be understood to be intended to designate the presence of features, numbers, steps, actions, components, parts, or combinations thereof described in the specification, and not preclude in advance the presence or possibility of addition of one or more other features, numbers, steps, actions, components, parts or combinations thereof.

### DESCRIPTION OF SYMBOL

100: Book Recommendation System
110: Control Unit
120: Emotion Graph Generating Unit
130: Emotion Graph Similarity Judgment Unit
140: Book Recommendation Unit
150: I/O Unit
160: User Activity Extraction Unit
101: Emotion Word Database
103: Emotion Graph Database
105: User Activity Database
107: Book Information Database

### MODE(S) FOR CARRYING OUT THE INVENTION

Hereinafter, examples of embodiments according to the present invention will be described in detail with reference to attached drawings, and in a description with reference to the attached drawings, identical or corresponding components are assigned the same drawing numbers, and redundant descriptions thereof will be omitted.

Also, terms such as first and second used hereinafter are merely identification symbols for distinguishing the same or corresponding components, and the same or corresponding components are not limited by terms such as first and second.

In addition, the term “combination” does not mean only a case in which each component is in direct physical contact with each other in the contact relationship between each component, but it should be used as a concept that encompasses the case when a different configuration is interposed between each component and each component is in contact with the other configuration.

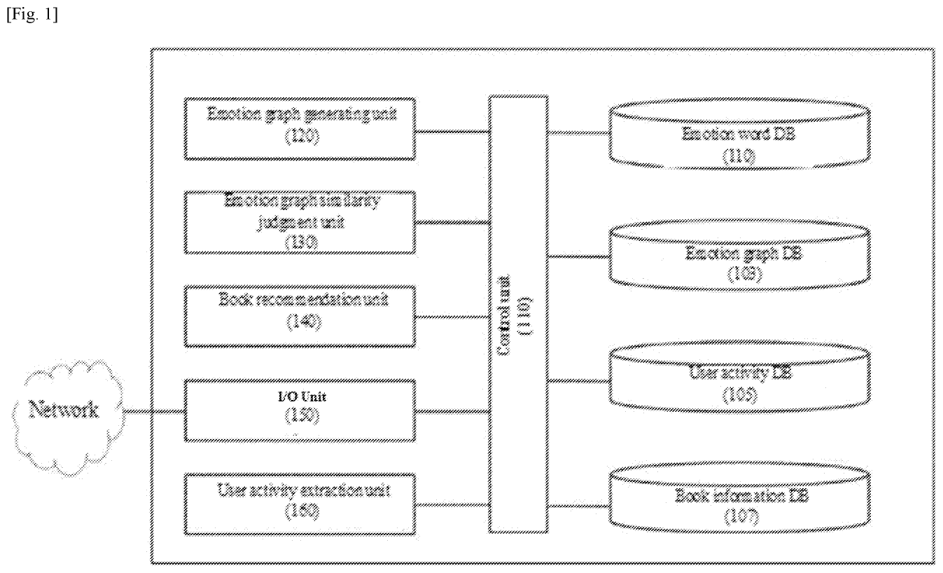

FIG. 1 is a configuration diagram of the book recommendation system according to the present invention. Referring to FIG. 1, the book recommendation system includes a control unit (110), an emotion graph generating unit (120), an emotion graph similarity judgment unit (130), a book recommendation unit (140), an input/output unit (150), and an emotion word database (101), an emotion graph database (103), a user activity database (105), and a book information database (107) are shown in diagrams. This book recommendation system can be a book recommendation server.

First, the control unit (110) serves to control the components such as the emotion graph generating unit, an emotion graph similarity judgment unit, a book recommendation unit, an input unit, and an output unit. For example, it may play a role of controlling the emotion graph generating unit so as to receive a control signal from a user and generate an emotion graph according to the control signal. Of course, the control unit can control each database connected to the control unit. FIG. 1 shows in diagram that various databases are included in a server which is a book recommendation system, but the databases may exist outside the server. In addition, although the detailed description and claim of the present invention refers to books, the application of the present invention is not limited to books, and all distinct texts that include print, such as web novels and cartoons, can be applied.

Next, the emotion graph generating unit (120) serves to generate an emotion graph for the story flow of books. Story flow can mean story development in chronological order from the first chapter to the last chapter of a book. In general, novels, essays, and travel essay, excluding descriptive writing and discourse texts, contain literary elements, and there is a flow of emotion in the text as a whole. For example, William Shakespeare's novel “Romeo and Juliet” has a story flow that includes various emotions such as family strife, love between Romeo and Juliet, forced marriage between Juliet and Paris, Romeo's suicide, Juliet's suicide, and reconciliation by both families. Specifically, if one of the emotions is considered from a perspective of happiness, the level of emotion is low in the strife between the two families in the beginning of the novel, the emotion is strong in the love of Romeo and Juliet in the middle, and the emotional level due to the duel near the end is low, but the feeling of happiness rises again due to reconciliation in the final chapter. In the case of books containing literary elements such as novels or essays, there is a change in emotions according to the story flow. The emotion graph generating unit plays a role of generating these emotional changes into an emotion graph.

Also, the emotion graph generating unit may select books for which the emotion graph is to be generated according to the story flow by using genre information of books that may be stored in the book information database. More specifically, when the genre information of the acquired book is a novel, the emotion graph generating unit inputs the story flow of the book to the emotion graph generating unit to generate the emotion graph. On the other hand, if the genre information of the book is a discourse texts, it is determined that there is no emotion to be extracted, and does not attempt to generate an emotion graph.

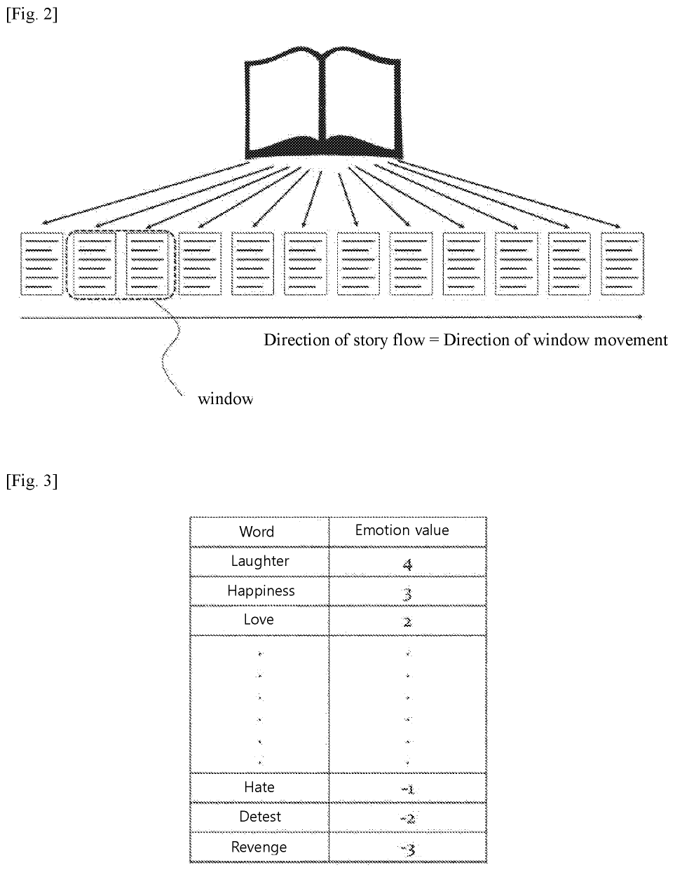

In addition, the emotion graph generating unit may analyze emotions in the book through a window. FIG. 2 is a conceptual diagram illustrating generation of a story flow emotion graph according to the present invention. Referring to FIG. 2, words constituting the story flow of a book are input into a memory (not shown), and words stored in the memory are divided into partial parts and sequentially read to perform emotion analysis. More specifically, for example, a book is a novel of composed of 10,000 words. For a book consisting of these 10,000 words, emotions are analyzed in units of 100 words, and the words subject to emotion analysis can be referred to as a window. By moving this window in a direction from the first word to the last word of the book, it is possible to calculate the emotion values of words included in the window.

The size of the window can be arbitrarily determined by the user. In the operational examples of embodiments of the present invention, a window having a size capable of windowing as many words as 1% of the total number of words in a book is determined. For example, if the entire novel contains 10,000 words, window can read 100 words. Of course, the size of the window is not limited to the example, and a window of various sizes may be provided.

The size of the window may be as good as having the average number of words included in the pages of a book. This allows window to be as large as each page of the book.

Also, the window can be moved in the direction of the story flow of the book. For example, suppose a book consisting of 10,000 words is moved by applying a window that can read 100 words. The position of the initial window is located in the first words to the hundredth word, and emotions can be extracted by analyzing the contents of the book where the initial window is located. Then, the window is moved one word at a time in the direction of the story flow. As a result, the window is located in the second word to the 101st word, and emotions of the corresponding words can be analyzed. By repeating this process, the window will be located in the last 9,901st word to the 10,000th word, and emotions of the corresponding words can be analyzed. Through this process, 9,901 of emotion analysis may be performed to complete the emotion analysis for the entire book. Meanwhile, since the first emotion analysis result value to the 9,901st emotion analysis result value is a repetition of the addition and deletion of a word, the result value may change smoothly. It is summarized as follows.
Number of words in the entire book=n
Size of window=number of words that can be included in window=m
Analysis target word in the window at position a in the book=the word in position a to the a+m−1^{th} word in the book
The nth word in the order of the story flow of the book=word (n)

### Example

Number of words in the entire book=10,000
Size of window=100
Analysis target words in the window at the first position=word (1) to word (100)
Analysis target words in the window at the second position=word (2) to word (101)

. . .
Analysis target words in the window at position 99,901=word (99,901) to word (10,000)

Meanwhile, the window can be moved in units of one word, but it is not limited thereto, and the emotion value can be calculated by moving one page at a time. In this case, since words are completely replaced in the window, the change in the emotion value may be somewhat large. For example, when the size of the window is set to the size of one page of the book and the unit of movement is also set to one page, an emotion result value for each page can be sequentially derived. In addition, the emotion values can be distributed discretely.

Then, a method of calculating the emotion value of the window will be described. The emotion graph generating unit calculates the degree of emotion by analyzing words included in the window. Specifically, it searches whether there is a word related to a specific emotion among the words in the window, and calculates a value for a specific degree of emotion by summing the scores given to the searched word. FIG. 3 is an emotion value table of words representing emotions of happiness included in the emotion word database 101. Looking at the emotion value table of happiness, the word “Laughter” has an emotion value of 4, and the emotion value of “Happiness” can be 3. It does not necessarily have positive emotion values, but there are also words that have negative emotion values. For example, the word “Hate” has an emotion value of −1, and the word “Revenge” has an emotion value of −3. The expression of the emotion value need not necessarily be limited to positive or negative numbers, and it is sufficient if the degree of the emotion value can be expressed. For example, it can also be expressed as good, fair, and poor.

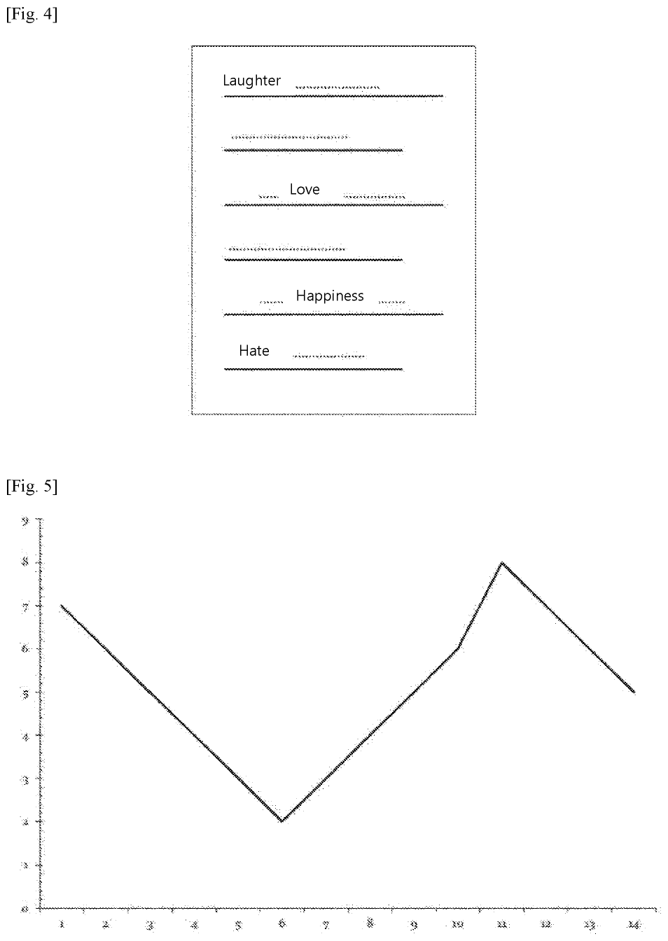

When the included words exist in the emotion value table, the final unit emotion sum value is calculated by summing the emotion values for each word. In other words, the unit emotion sum value can mean the sum of emotion values of words included in a single window. FIG. 4 shows a page in which words where the emotion value is assigned are present. For example, in the page of FIG. 4, the words for the emotion of happiness, such as “Laughter”, “Love”, “Happiness”, and “Hate”, are searched. If the emotion values of the words related to each emotion are summed, the sum of the unit emotions on this page is Laughter (4)+Love (2)+Happiness (3)+Hate (−2) is calculated as 7 points. If the sum value of the unit emotions is repeatedly calculated in the direction of the story flow, the emotion graph of the book in respect to the emotion of happiness can be derived. FIG. 5 is a graph showing unit emotion values according to this direction of story flow.

In this example, the emotion graph is generated only for the emotion of happiness, but is not limited thereto, and various emotion graphs such as “Happiness”, “Surprise”, “Regret”, “Loneliness”, and “Fear” may be generated. To this end, various emotion tables may exist in the emotion word database, and various words may exist in the emotion table. In addition, when calculating the emotion value, it is not necessary to be limited to whether or not the words are identical, and the emotion values may be calculated in units of morphemes, which are the smallest units of meaning.

The emotion graph similarity judgment unit (130) serves to determine the similarity between the emotion graphs of each book. More specifically, based on the first similarity judgment base value, which represents the difference between the unit emotion sum values of the first book and the second book, and the second similarity judgment base value, which represents the amount of change in the first similarity judgment base value, the similarity between the first and second books is determined. Also, as mentioned earlier, it is not limited to one emotion, but the similarity between the two books can be finally derived by measuring the similarity between several emotion graphs.

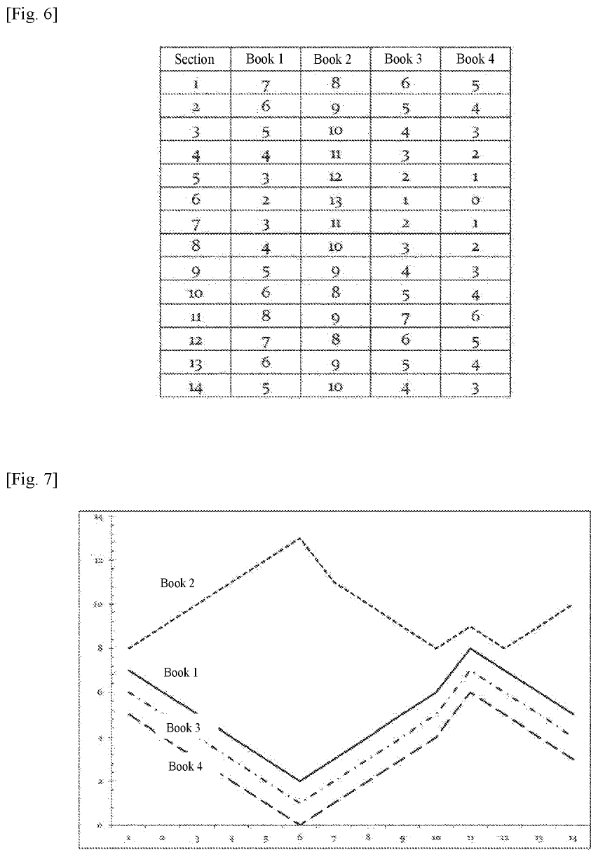

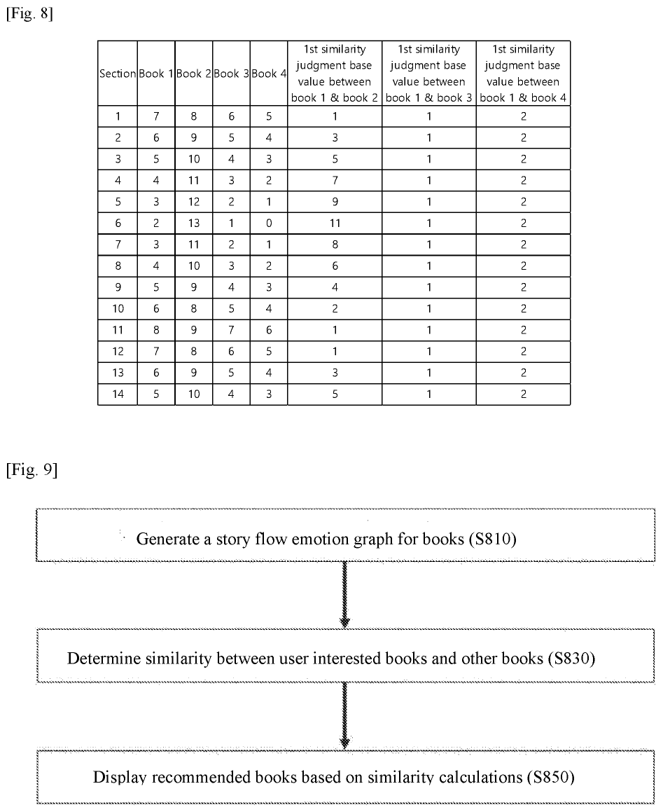

FIG. 6 is the table showing the unit emotion sum values for each section of books 1 to 4, and FIG. 7 is a graph showing these values. Referring to FIG. 6 and FIG. 7, the difference in the unit emotion sum values for each section between Book 1 and Book 2 is shown in FIG. 8. The first similarity judgment base value means the difference between the unit emotion sum values of the first and second books according to the story direction, and the second similarity judgment base value indicates the amount of change in the first similarity judgment base value. Referring to FIG. 8, the first similarity judgment base values between Book 1 and Book 2 are listed as “1, 3, 5, 7, 9, 11, 8, 6, 4, 2, 1, 1, 3, 5.” On the other hand, the first similarity judgment base value between Book 1 and Book 3 are all 1. The emotion graph similarity judgment unit determines that the smaller the difference between the unit emotion sum value of both books, the more similar it is. In other words, it is determined that the smaller the first similarity judgment base value, the more similar both books are. Accordingly, referring to FIG. 8, the emotion graph similarity judgment unit can determine that Book 3 is more similar to Book 1 than Book 2. In addition, when examining the second similarity judgment base value, the second similarity judgment base value is also large because the amount of change in the first similarity judgment base value between Book 1 and Book 2 is large. On the other hand, since there is no amount of change in the first similarity judgment base value between Book 1 and Book 3, the second similarity judgment base value is 0. Therefore, the emotion graph similarity judgment unit can determine that books 1 and 3 with lower second similarity judgment base value are more similar to those of books 1 and 2. The emotion graph similarity judgment unit can determine similarity between the two books by mixing at least one of the first similarity judgment base value and the second similarity judgment base value. Also, the similarity between two books can be measured by assigning a weight to the similarity judgment base value according to the characteristics of the book.

Since there is no change in the first similarity judgment base value between Book 1 and Book 3, and between Book 1 and Book 4, the second similarity judgment base value becomes 0. However, since there is a difference in the first similarity judgment base value, the emotion graph similarity judgment unit may determine that between Book 1 and Book 3, which have a smaller value, are more similar than Book 1 and Book 4.

The book recommendation unit (140) selects books and recommends to users that have been given a rating score higher than a predetermined reference value by the user, books included in the shopping cart of an online shopping mall, or books similar to books in which book information has been viewed in an online space by the user. The roles can be served by a similar book extraction module (not shown) in the book recommendation unit.

More specifically, the book recommendation system ultimately serves to recommend books that users will be interested in. At this time, the book recommendation unit of the book recommendation system can recommend similar books by analyzing the user's activity pattern. Even more specifically, in order to provide the user's personalized information and user customized book recommendation, the user's online activity is identified and utilized for selection of book recommendations. For example, if a user has given a high rating score for a particular book on an online website, etc., books similar to the books are selected and recommended through the emotion graph similarity judgment unit. In addition, when a user has purchased a particular book at an online bookstore such as Amazon (registered trademark) or has previously put it in a shopping cart to make a purchase, it is possible to select books similar to the particular book and provide recommendation information to the user. Also, when a user has read a book review for a specific book in an online community or a review site, books similar to the book may be selected.

Various book information such as a website on an external online space, for example, a Social Networking Service site, an online bookstore site, and an online book review site, and the user's activity information for the book can be extracted from the sites through the user activity extraction unit (160). The user activity information extracted through the user activity extraction unit may be stored in the user activity database.

Also, the book recommendation unit may randomly recommend selected books. Previously, if the book extraction unit, especially the similar book extraction module, selected similar books in consideration of the user's activity, a selection recommendation module (not shown) of the book extraction unit lastly outputs the selected similar books according to predetermined criteria. In other words, the output role can be performed by the selection recommendation module in the book recommendation unit. The selection recommendation module can recommend the remaining books except for those that users have already read among similar books extracted by the similar book extraction module. In addition, the remaining books can be recommended except for books with low ratings by users, other users, and critics. Alternatively, it may be recommended to exclude books that are inappropriate for the user to read in consideration of user information. The selection recommendation module serves to exclude books that will not be recommended based on predetermined criteria among similar books. On the other hand, the selection recommendation module may reference a book information database for selection of books. Various information about each book can be included in the book information database. In addition, the selection recommendation module can finally recommend books by linking the user activity database with the book information database. This is because, for example, information on books already read by a specific user can be stored in the user activity database.

In addition, the selection recommendation module may classify and display books extracted from the similar book extraction module according to specific criteria. One or more books can be displayed in the order of book ratings. In this case, the rating of each book can be called up using the book information database, and this is utilized. Also, books may be sorted and displayed based on information such as cumulative sales volume and sales volume by period for each similar book.

In addition, similar books can be sorted and displayed using personalized information customized to individual users. For example, information of the age of a user's personal information could be used to display the books preferred by users of similar age groups in order of preference. Also, a specific similar book among similar books can be displayed first in consideration of gender or disposition among other personal information. These operations can be performed using user personal information stored in the user activity database.

Looking at the database, the emotion word database stores words related to emotions. In addition, the control unit, the emotion graph generating unit, etc. generate the emotion graph by referring to the emotion word database. For example, speaking of the emotion of happiness, various related words such as laughter, smile, and satisfaction, can be stored. The emotion graph database can store the emotion graph for each analyzed book. The user activity database, as previously described, can include various book information, such as Social Networking Services site, online bookstore site, online book review site, and the user activity information for the book. Finally, the book information database can include information related to books, such as the information about the title of the book, author of the book, and publication year of the book.

FIG. 9 to FIG. 12 are operations flow charts according to the present invention. It will be described excluding overlapping descriptions of the book recommendation system under the present invention of FIG. 1 to FIG. 8. Referring to FIG. 9, the book recommendation server generates an emotion graph based on the story flow of the books (S810). Next, the book recommendation server determines the similarity between the book (interesting book) that the user is interested in and other books (S830). As previously described, similarity can be determined by measuring the similarity of the emotion graph. Similar books are displayed as recommended books through the similarity calculation (S850).

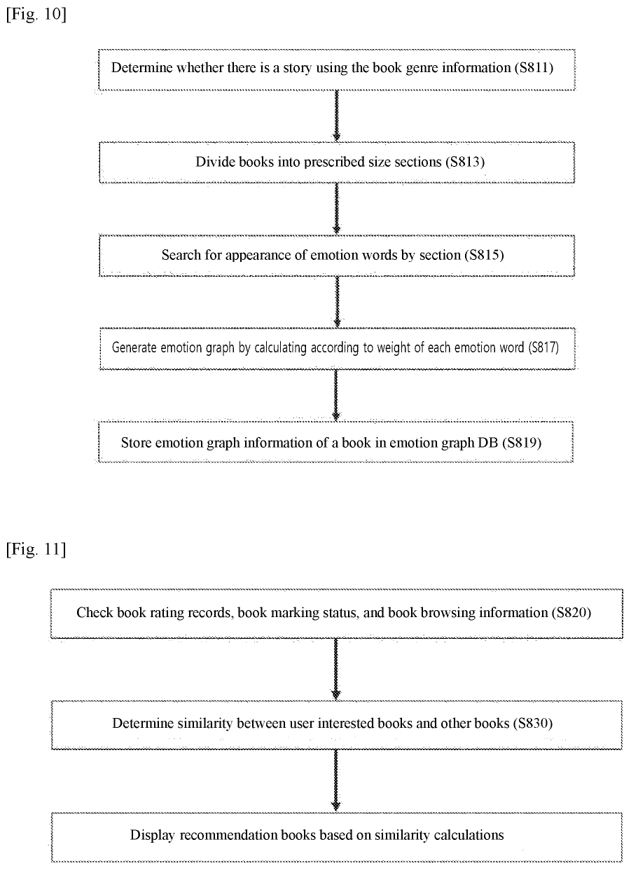

FIG. 10 is the flow chart that further analyzes the steps of generating an emotion graph based on a story flow. Referring to FIG. 10, the book recommendation server determines whether or not a story exists by using the genre information of the book (S811). Next, the book recommendation server divides the book into sections of a prescribed size (S813). Then, the book recommendation server counts the appearance of emotion words in each section (S815). Then, the book recommendation server calculates the unit emotion sum value according to sections by calculating the weight for each emotion word, and generates an emotion graph according to the value (S817). The information on the graph is stored in the emotion graph database (S819).

FIG. 11 is the diagram showing a preprocessing step for extracting a book to be recommended to a user. Referring to FIG. 11, the book recommendation server identifies books that have been well received by users, books that have been placed in the shopping cart of online shopping malls, books that have been liked with the like function in online shopping malls, and books that users have read information about books (S820). The book recommendation server determines that the book is of interest to the user and analyzes the similarity between the book of interest and other books (S830). The book recommendation server displays similar books based on the similarity (S850).

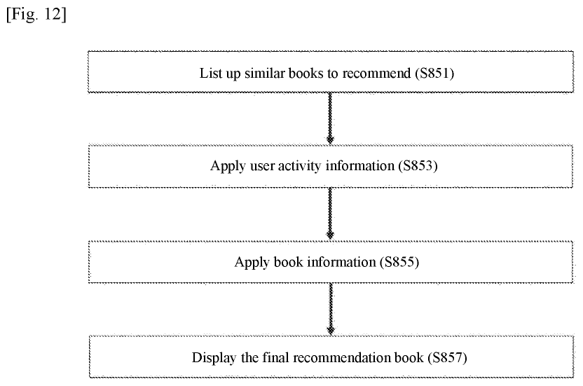

FIG. 12 is the flow chart described by analyzing the step of displaying recommended books based on similarity calculations. Referring to FIG. 12, a list of similar books to be recommended by the book recommendation server is extracted (S851). The book recommendation server filters a list of similar books by applying user activity information, for example, book information that the user has already read, among the extracted books (S853). User activity information may include various information such as gender, age, and Social Networking Service usage pattern. Next, the book recommendation server filters the list of similar books by applying book information, for example, rating information or sales volume information (S855). Subsequently, filtered books are finally displayed (S857). Meanwhile, although it was expressed as filtering, filtering can be understood as the concept of sorting books. Furthermore, steps S851 and S855 do not need to be limited to sequential steps, and the order may be changed.

Through the book recommendation system and book recommendation method, it is possible to recommend appropriate books to users according to their tastes.

The methods and processes described are, for example, the commands for execution by a processor, controller, or other processing device, and may be encoded and stored in compact disk read only memory (CDROM), magnetic or optical disk, flash memory, random access memory (RAM) or read only memory (ROM), erasable and programmable read only memory (EPROM), or other machine readable media, such as machine readable or computer readable media.

Such medium may be implemented as an arbitrary device that contains, stores, communicates, propagates or moves executable commands for use by or in connection with a command executable system, equipment, or device. Alternatively, or additionally, it may be implemented as analog or digital logic using hardware, such as one or more integrated circuits, or one or more processor execution commands; or as software for functions defined as an application programming interfaces (API) or Dynamic Link Library (DLL), a local or remote procedure call, or available in shared memory; or as a combination of hardware and software.

In other embodiments, the method may be represented as a signal or radio-signal medium. For example, commands that implement the logic of any given program may take the form of electrical, magnetic, optical, electromagnetic, infrared, or other types of signals. The system described above receives these signals from a communication interface such as a fiber optic interface, antenna, or other analog or digital signal interface, restores commands from the signal, stores them in machine readable memory, and/or executes them using a processor.

As stated above, the operational examples of embodiments of the present invention have been described, but a person with ordinary knowledge in the relevant field of technology will be able to modify and change the present invention in various ways by adding, changing, deleting components within the scope not departing from the idea of the present invention described in the patent claims. This will also be said to be included within the scope of the rights of the present invention.

### INDUSTRIAL APPLICABILITY

It can be used for the method of recommending books using similarity between books.

1. A book recommendation method using similarity between books, including:
(1) A step in which a book recommendation server generates a story flow emotion graph for each of the plural number of books;
(2) A step in which the book recommendation server calculates the similarity between the story flow emotion graph of a first book and the story flow emotion graph of a second book; and
(3) A step of displaying one or more similar books similar to the first book according to the similarity by the book recommendation server.

2. The book recommendation method using similarity between books of claim 1,
wherein the step (1) includes,
A step of selecting a target book to generate the story flow emotion graph using a genre information of the book.

3. The book recommendation method using similarity between books of claim 1,
wherein the step (1) includes,
A step of generating a window that analyzes as many words as a prescribed ratio with respect to the total number of words included in each book; and,
A step of generating the story flow emotion graph by sequentially moving the window from the word at a first position included in each book to the story direction of the book, which is a word direction at a second position, and by analyzing the emotions of the words included within the window at a position in the moved book.

4. The book recommendation method using similarity between books of claim 3,
wherein the step of generating the story flow emotion graph by sequentially moving the window from the word at the first position included in each book to the story direction of the book, which is the word direction at the second position, and by analyzing the emotions included within the window at the position in the moved book includes,
A step of assigning an emotion value for each word included in the window by referring to words included in the predefined emotion word table;
A step of deriving a unit emotion sum value obtained by summing emotion values for each word in the window; and,
A step of generating data for the story flow emotion graph based on the unit emotion sum value.

5. The book recommendation method using similarity between books of claim 3,
wherein the step of generating the story flow emotion graph by sequentially moving the window from the word at the first position included in each book to the story direction of the book, which is the word direction at the second position, and by analyzing the emotions included within the window at the position in the moved book,
Moves the window by an average number of words of the number of words included in each page of the book to be analyzed.

6. The book recommendation method using similarity between books of claim 4,
wherein the step (2) calculates based on one or more of the follows:
A first similarity judgment base value indicating the difference between the unit emotion sum value of the first book according to the story direction and the unit emotion sum value of the second book according to the story direction; and,
A second similarity judgment base value representing an amount of change of the first similarity judgment base value.

7. The book recommendation method using similarity between books of claim 1
wherein the first book is,
A book that has been given a rating score higher than a predetermined reference value by a user;
A book included in a shopping cart of an online shopping mall; or,
A book in which related book information has been viewed in an online space by the user.

8. The book recommendation method of claim 1,
wherein the step (3) includes,
A step of excluding books read by the user among one or more of the similar books;
A step of displaying similar books in order of book ratings among one or more of the similar books; and
A step of displaying similar books in consideration of user information among one or more of the similar books.
